(19) United States
(12) Patent Application Publication
(10) Pub. No.: US 2018/0173619 A1
(43) Pub. Date: Jun. 21, 2018

(54) System and Method for Distributed Logical to Physical Address Mapping

(71) Applicant: SanDisk Technologies LLC, Plano, TX (US)

(72) Inventors: Vijay Sivasankaran, Bangalore (IN); Srinivasa Rao Sabbineni, Bangalore (IN); Saugata Das, Bangalore (IN); Indraneel Mukherjee, Bangalore (IN); Nitin Gupta, Bangalore (IN)

(21) Appl. No.: 15/491,917

(22) Filed: Apr. 19, 2017

Related U.S. Application Data
(60) Provisional application No. 62/437,625, filed on Dec. 21, 2016.

(51) Int. Cl. G06F 12/02; G06F 3/06

(52) U.S. Cl. CPC G06F 12/0246; G06F 3/0679; G06F 3/0659; G06F 2212/7201; G06F 3/065; G06F 3/0619; G06F 3/061

(57) ABSTRACT

In a storage device having a storage controller and multiple memory channels, each memory channel has a memory channel controller. The storage controller, in response to a host command to perform a respective read operation at a logical address specified by the host command, identifies the memory channel based on the specified logical address, and also identifies a portion of logical to physical address mapping information corresponding to the logical address. The storage controller sends to a controller of the identified memory channel a read command that includes information identifying the portion of logical to physical address mapping information corresponding to the logical address. Using that information, the memory channel controller translates the logical address into a physical address and reads data from the physical address.

### RELATED APPLICATIONS

This application claims priority to U.S. Provisional Patent Application No. 62/437,625, filed Dec. 21, 2016, which is hereby incorporated by reference in its entirety.

### TECHNICAL FIELD

The disclosed embodiments relate generally to memory systems, and in particular, to enable scalable and distributed address mapping of storage devices (e.g., memory devices).

### BACKGROUND

Semiconductor memory devices, including flash memory, typically utilize memory cells to store data as electrical values, such as electrical charges or voltages. A flash memory cell, for example, includes a single transistor with a floating gate that is used to store a charge representative of a data value. Flash memory is a non-volatile data storage device that can be electrically erased and reprogrammed. More generally, non-volatile memory (e.g., flash memory, as well as other types of non-volatile memory implemented using any of a variety of technologies) retains stored information even when not powered, as opposed to volatile memory, which requires power to maintain the stored information.

The data storage operations of flash memories typically comprise three basic operations: page read, page write (also called page program), and block erase. Before a page can be programmed or re-programmed, a block erase of the block containing the page is performed first. As a result, data is stored in physical memory locations in a flash memory device that do not correspond to the logical order of the data. In order to locate the physical memory locations, software and hardware architectures of a flash memory device typically include a flash translation layer (FTL) that is responsible for translating logical addresses of data to and from physical memory addresses at which data are or will be stored in the flash memory device.

As capacity of flash memory devices increases, the dynamic random access memory (DRAM) required for storing the FTL mapping tables also increases, at corresponding increased cost. Furthermore, in typical usage, large portions of the FTL mapping tables are unused, or largely unused, for long periods of time.

### SUMMARY

Various implementations of systems, methods and devices within the scope of the appended claims each have several aspects, no single one of which is solely responsible for the attributes described herein. Without limiting the scope of the appended claims, after considering this disclosure, and particularly after considering the section entitled “Detailed Description” one will understand how the aspects of various implementations are used to enable scalable and distributed address mapping in storage devices. In one aspect, a storage device having a storage controller, and nonvolatile memory in multiple memory channels stores in each memory channel data and corresponding logical to physical address mapping information. In another aspect, for at least some memory operations, logical to physical address mapping is performed by memory channel controllers, which are distinct from the storage controller. As a result, the entirety of the logical to physical address mapping information need not be stored in the storage controller's random access memory.

### BRIEF DESCRIPTION OF THE DRAWINGS

So that the present disclosure can be understood in greater detail, a more particular description may be had by reference to the features of various implementations, some of which are illustrated in the appended drawings. The appended drawings, however, merely illustrate the more pertinent features of the present disclosure and are therefore not to be considered limiting, for the description may admit to other effective features.

FIG. 1 is a block diagram illustrating an implementation of a data storage system, in accordance with some embodiments.

FIG. 2A is a block diagram illustrating an implementation of a management module of a storage device controller, in accordance with some embodiments.

FIG. 2B is a block diagram illustrating an implementation of a memory channel, in accordance with some embodiments.

FIG. 3 illustrates various logical to physical memory address translation tables, in accordance with some embodiments.

FIGS. 4A-4B illustrate a flowchart representation of a method of operating a storage having non-volatile memory, in accordance with some embodiments.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

The various implementations described herein include systems, methods and/or devices used to enable larger amounts of non-volatile memory to be provided in a storage device.

As the electronics industry progresses, the memory storage needs for electronic devices ranging from smart phones to server systems are rapidly growing. For example, as enterprise applications mature, the capacity of storage devices required for these applications have dramatically increased. As the capacity has increased, correspondingly, the size of the address translation tables used for mapping logical addresses to and from physical addresses has also increased, and the workload of storage controllers has also increased.

In order to effectively manage non-volatile memories in storage devices, some implementations described herein use scalable techniques of managing the storage of data in multiple memory channels, where each memory channel includes an offload controller (sometimes called a channel controller or memory channel controller), and one or more memory die. Each memory channel typically includes multiple memory die. As memory storage needs increase, the memory capacity of a single storage device can be increased by adding one or more additional memory channels, and/or by adding more memory die to one or more of the memory channels.

As noted, each memory channel in the storage device includes an offload controller. As an example of one of its functions, an offload controller manages address mapping within a particular memory channel for at least for some memory operations, and thereby reduces the work needed to be done by a storage controller of the storage device. As result of this reduction in the work that needs to be done by the storage controller, the storage controller can provide higher performance for other operations in the storage device, and can therefore manage a greater amount of non-volatile memory than if the storage controller were handling all address mapping and other non-volatile memory management tasks for the storage device.

(A1) In some embodiments, a method of operating a storage device includes receiving a host command to perform a respective read operation on the portion of the storage device's non-volatile memory corresponding to a logical address specified by the host command. The method also includes, at a storage controller for the storage device, identifying, based on the specified logical address, a memory channel of a plurality of memory channels. Each memory channel of the plurality of memory channels includes a portion of the non-volatile memory of the storage device, an offload controller, and logical to physical (L2P) address mapping information for portions of the non-volatile memory of the storage device in the memory channel. The method further includes identifying, based on the specified logical address, a portion of the L2P address mapping information in the identified memory channel and sending to the offload controller of the identified memory channel, a read command. The read command includes at least a portion of the logical address specified by the received host command and information identifying the identified portion of the L2P address mapping information in the identified memory channel. The method further includes, at the offload controller of the identified memory channel, mapping the logical address specified by the received host command to a physical address using the identified portion of the L2P address mapping information in the identified memory channel. Thus, the physical address corresponds to the logical address specified by the host command. The method further includes performing the respective read operation on a portion of the non-volatile memory in the identified memory channel identified by the physical address, and returning the read data obtained by performing the respective read operation.

(A2) In some embodiments of the method of A1, identifying the portion of the L2P address mapping information in the identified memory channel includes identifying a page of an L2P log and an offset, within the identified page of the L2P log, corresponding to the specified logical address; wherein the identified page of the L2P log is stored in the identified memory channel.

(A3) In some embodiments of the method of A2, in the read command, the information identifying the identified portion of the L2P address mapping information in the identified memory channel includes a physical address of the identified portion of the L2P address mapping information.

(A4) In some embodiments of the method of any of A1-A3, the read command further includes a buffer identifier or address, and returning the read data includes copying the read data to a buffer location corresponding to the buffer identifier or address.

(A5) In some embodiments of the method of A1, the method further includes, at the offload controller of the identified memory channel, marking a physical memory location as busy while performing the respective read operation, and unmarking the physical memory location as busy after completion of the respective read operation.

(A6) In some embodiments of the method of any of A1-A5, the offload controllers of the plurality of memory channels each individually execute respective read operations.

(A7) In some embodiments of the method of any of A1-A6, each offload controller in the plurality of memory channels includes a garbage collection module to copy data from a source location to a destination location, wherein the source location and destination location are both located within the portion of the non-volatile memory of the storage device in the memory channel that includes the offload controller.

(A8) In some embodiments of the method of A7, the garbage collection module in a respective offload controller, for a respective memory channel, receives from the storage controller a plurality of parameters including a source physical block and page number, a destination physical block and page number, and a number of pages of data to be copied; wherein the source physical block and destination physical block are both located within the portion of the non-volatile memory of the storage device in the respective memory channel.

(A9) In some embodiments of the method of any of A1-A8, returning the read data includes sending an interrupt to the storage controller.

(A10) In another aspect, a storage device includes (1) non-volatile memory, (2) an interface for coupling the storage device to a host system and for receiving a host command to perform a respective read operation on a portion of the non-volatile memory corresponding to a logical address specified by the host command, (3) a plurality of memory channels, each memory channel of the plurality of memory channels including a portion of the non-volatile memory of the storage device, an offload controller, logical to physical (L2P) address mapping information for portions of the non-volatile memory of the storage device in the memory channel, and (4) a storage controller. The storage controller includes one or more hardware processors and is configured to: (a) identify, based on the specified logical address, a memory channel of the plurality of memory channels, (b) identify, based on the specified logical address, a portion of the L2P address mapping information in the identified memory channel, (c), send to the offload controller of the identified memory channel, a read command, the read command including at least a portion of the logical address specified by the received host command and information identifying the identified portion of the L2P address mapping information in the identified memory channel. The offload controller of the identified memory channel is configured to: (i) map the logical address specified by the received host command to a physical address using the identified portion of the L2P address mapping information in the identified memory channel, the physical address corresponding to the logical address specified by the host command, (ii) perform the respective read operation on a portion of the non-volatile memory in the identified memory channel identified by the physical address, and (iii) return read data obtained by performing the respective read operation.

(A11) In some embodiments, the storage device of A10 is configured to perform the method of any of A1 to A9.

(A12) In yet another aspect, a storage device includes a plurality of memory channels, each memory channel of the plurality of memory channels including a portion of the non-volatile memory of the storage device, and logical to physical (L2P) address mapping information for portions of the non-volatile memory of the storage device in the memory channel. The storage device includes means for coupling the storage device to a host system, and for receiving a host command to perform a respective read operation on a portion of the non-volatile memory corresponding to a logical address specified by the host command. The storage device further includes means for controlling operation of the storage device, including: means for identifying, based on the specified logical address, a memory channel of a plurality of memory channels; means for identifying, based on the specified logical address, a portion of the L2P address mapping information in the identified memory channel; and means for sending to the identified memory channel, a read command, the read command including at least a portion of the logical address specified by the received host command and information identifying the identified portion of the L2P address mapping information in the identified memory channel. The storage device further includes means for controlling operation of the identified memory channel, including: means for mapping the logical address specified by the received host command to a physical address using the identified portion of the L2P address mapping information in the identified memory channel, the physical address corresponding to the logical address specified by the host command; means for performing the respective read operation on a portion of the non-volatile memory in the identified memory channel identified by the physical address; and means for returning read data obtained by performing the respective read operation.

(A13) In some embodiments of the storage device of A12, the storage device is configured to perform the method of any of A1 to A9.

Numerous details are described herein in order to provide a thorough understanding of the example implementations illustrated in the accompanying drawings. However, some embodiments may be practiced without many of the specific details, and the scope of the claims is only limited by those features and aspects specifically recited in the claims. Furthermore, well-known methods, components, and circuits have not been described in exhaustive detail so as not to unnecessarily obscure more pertinent aspects of the implementations described herein.

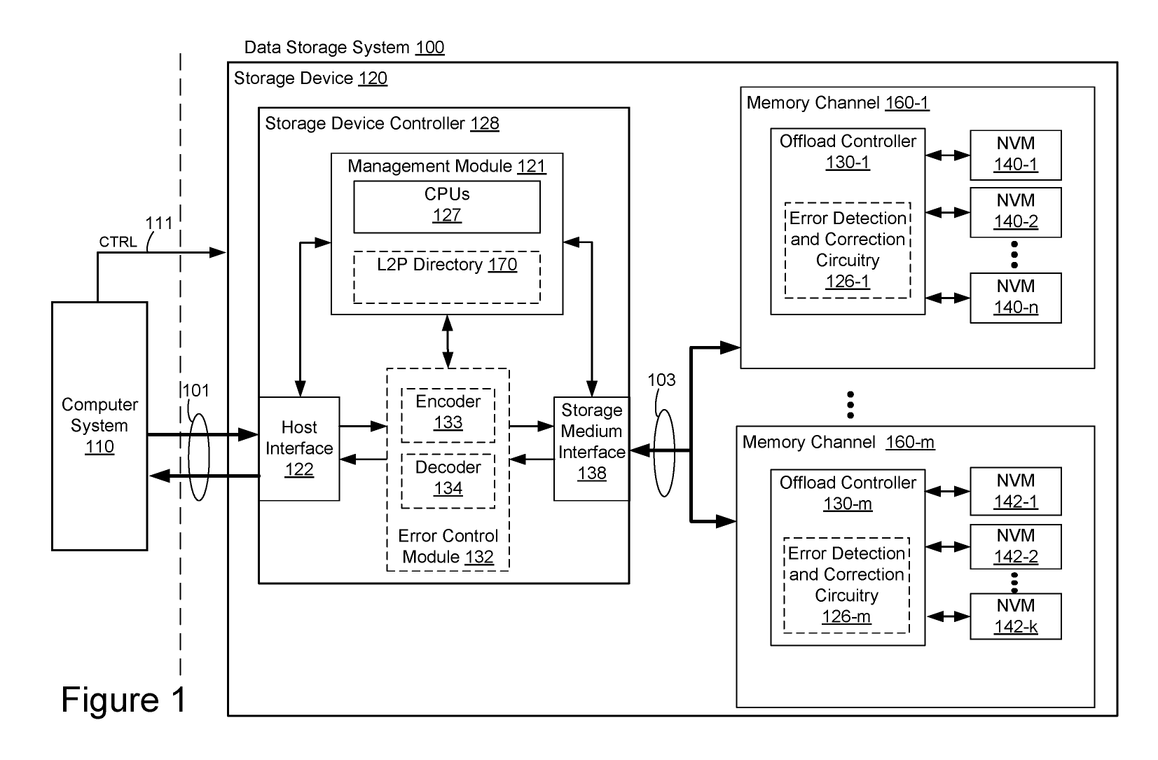

FIG. 1 is a block diagram illustrating an implementation of a data storage system 100, in accordance with some embodiments. While some example features are illustrated, various other features have not been illustrated for the sake of brevity and so as not to obscure more pertinent aspects of the example implementations disclosed herein. To that end, as a non-limiting example, data storage system 100 includes storage device 120, which includes storage device controller 128 (sometimes herein called the storage controller), and one or more memory channels 160 (e.g., memory channels 160-1 to 160-m). The storage device 120 is used in conjunction with or includes computer system 110 (e.g., a host system or a host computer).

Computer system 110 is coupled to storage device 120 through data connections 101. However, in some implementations computer system 110 includes storage device 120 as a component and/or sub-system. Computer system 110 may be any suitable computer device, such as a personal computer, a workstation, a computer server, or any other computing device. Computer system 110 is sometimes called a host or host system. In some implementations, computer system 110 includes one or more processors, one or more types of memory, optionally includes a display and/or other user interface components such as a keyboard, a touch screen display, a mouse, a track-pad, a digital camera and/or any number of supplemental devices to add functionality. Further, in some implementations, computer system 110 sends one or more host commands (e.g., read commands and/or write commands) on control line 111 to storage device 120. In some implementations, computer system 110 is a server system, such as a server system in a data center, and does not have a display and other user interface components.

Storage device controller 128 includes host interface 122, management module 121, error control module 132, and storage medium interface 138. Storage device controller 128 may include various additional features that have not been illustrated for the sake of brevity and so as not to obscure more pertinent features of the example implementations disclosed herein, and that a different arrangement of features may be possible.

Host interface 122 provides an interface to computer system 110 through data connections 101. Similarly, storage medium interface 138 provides an interface to memory channels 160 though connections 103. Connections 103 are sometimes called data connections, but typically convey commands in addition to data, and optionally convey metadata, error correction information and/or other information in addition to data values to be stored in memory channels 160 and data values read from memory channels 160. In some implementations, storage medium interface 138 includes read and write circuitry, including circuitry capable of providing read signals to memory channels 160 (e.g., signals representing threshold voltages to be used when reading data from NAND-type flash memory). In some embodiments, connections 101 and connections 103 are implemented as communication media over which commands and data are communicated, and each of these connections uses a protocol such as DDR3, SCSI, SATA, SAS, or the like for handling such communications.

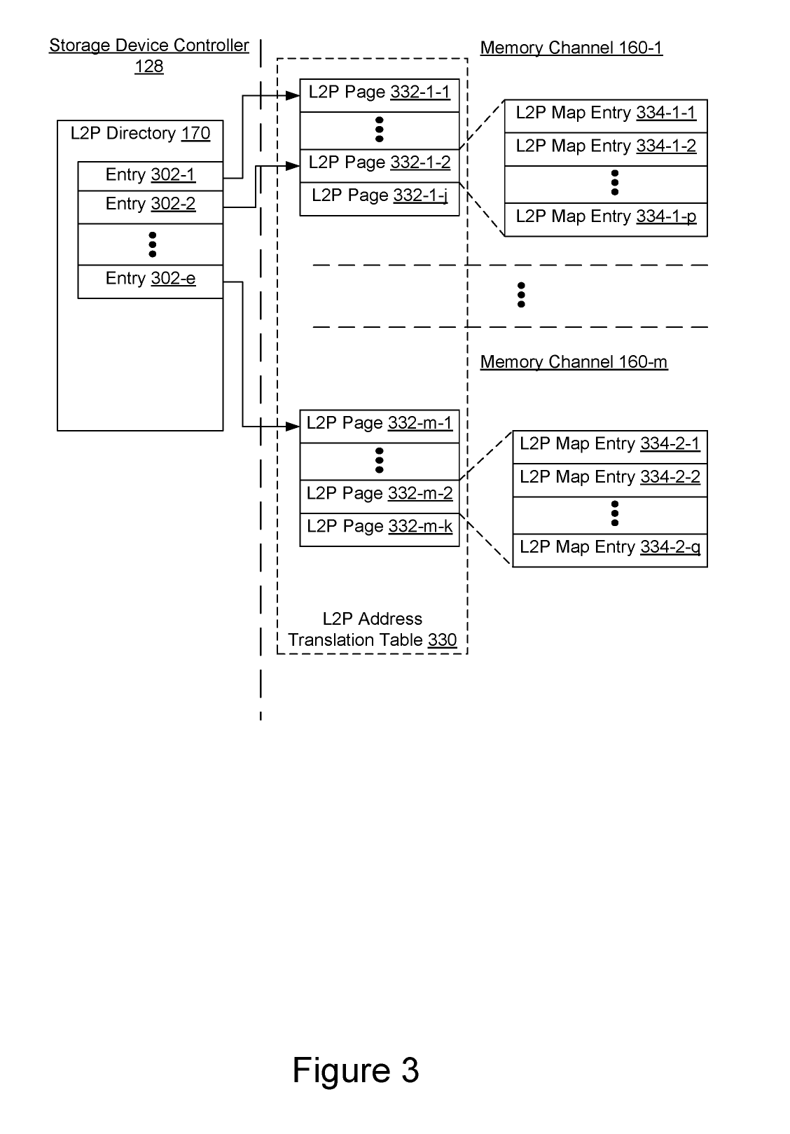

In some implementations, management module 121 includes one or more processing units 127 (sometimes herein called CPUs, processors, or hardware processors, and sometimes implemented using microprocessors, microcontrollers, or the like) configured to execute instructions in one or more programs (e.g., in management module 121). In some implementations, the one or more processing units 127 are shared by one or more components within, and in some cases, outside storage device controller 128. Management module 121 is coupled to host interface 122, error control module 132, and storage medium interface 138 in order to coordinate the operation of these components. In some embodiments, storage device controller 128 also includes a logical to physical directory 170, sometimes herein called a top-level address translation table or first level address translation table. In some embodiments, logical to physical (L2P) directory 170 is a logical to physical address table that maps a portion of a logical address (e.g., a predefined number of the most significant bits of the logical address) to a physical address within a respective memory channel 160. In some embodiments, a portion of the physical address, stored in L2P directory 170, determines which memory channel 160 to access. This will be described in greater detail below with reference to FIG. 3.

Error control module 132 is coupled to host interface 122, management module 121, and storage medium interface 138. Error control module 132 is provided to limit the number of uncorrectable errors inadvertently introduced into data. In some embodiments, error control module 132 includes an encoder 133 and a decoder 134. Encoder 133 encodes data by applying an error control code to produce a codeword, which is subsequently stored in non-volatile memory (e.g., in one of NVM devices 140, 142). In some embodiments, when the encoded data (e.g., one or more codewords) is read from non-volatile memory, decoder 134 applies a decoding process to the encoded data to recover the data, and to correct errors in the recovered data within the error correcting capability of the error control code. For the sake of brevity, an exhaustive description of the various types of encoding and decoding algorithms generally available and known to those skilled in the art is not provided herein.

In some embodiments, each memory channel 160 coupled to storage device controller 128 through connections 103 includes an offload controller 130 (e.g., a respective offload controller of offload controllers 130-1 to 130-m), and one or more NVM devices 140, 142 (e.g., flash memory die). In some embodiments, each offload controller 130 (sometimes called a channel controller or memory channel controller) includes one or more processing units 228 (sometimes herein called CPUs, processors, or hardware processors, and sometimes implemented using microprocessors, microcontrollers, or the like) configured to execute instructions in one or more programs (e.g., one or more programs stored in controller memory of the offload controller). In some embodiments, NVM devices 140, 142 are coupled to offload controllers 130 through connections that convey commands in addition to data, and optionally convey metadata, error correction information and/or other information in addition to data values to be stored in NVM devices 140, 142 and data values read from NVM devices 140, 142.

In some embodiments, storage device 120, memory channels 160, and/or NVM devices 140, 142 are configured for enterprise storage suitable for applications such as cloud computing, or for caching data stored (or to be stored) in secondary storage, such as hard disk drives. Additionally and/or alternatively, storage device 120, memory channel 160, and/or NVM devices 140, 142 are configured for relatively smaller-scale applications such as personal flash drives or hard-disk replacements for personal, laptop and tablet computers. While in some embodiments NVM devices 140, 142 are flash memory devices and offload controllers 130 are flash memory controllers or solid state storage controllers, in other embodiments storage device 120 may include other types of non-volatile memory devices and corresponding controllers.

In some embodiments, each offload controller 130 includes error detection and correction circuitry 126. In these embodiments, error detection and correction circuitry 126 is used to encode data being written to NVM devices 140, 142, and decode data being read from NVM devices 140, 142, and detect and correct data errors during data decoding. In some embodiments, error detection and correction circuitry 126 includes an encoder and a decoder. The encoder encodes data by applying an error control code to produce a codeword, which is subsequently stored in non-volatile memory. When the encoded data (e.g., one or more codewords) is read from non-volatile memory, the decoder applies a decoding process to the encoded data to recover the data, and to correct errors in the recovered data within the error correcting capability of the error control code.

Optionally, in such embodiments storage device controller 128 does not include error control module 132, because the error control functions that would otherwise be performed by are error control module 132 are instead handled by error detection and correction circuitry 126 in the memory channel 160. In some embodiments, error detection and correction circuitry 126 includes one or more hardware processing units. In some embodiments, error detection and correction circuitry 126 is implemented using a hardware state machine, and in some embodiments, error detection and correction circuitry 126 is implemented in an application-specific integrated circuit (ASIC). In some embodiments, error detection and correction circuitry 126 uses one or more error detection and/or correction schemes, such as Hamming, Reed-Solomon (RS), Bose Chaudhuri Hocquenghem (BCH), low-density parity-check (LDPC), or the like.

Typically, if error detection and correction circuitry 126 is included in the offload controller 130 of a respective memory channel 160, error detection and correction circuitry 126 is coupled to storage device controller 128 and to the NVM devices in the respective memory channel in order to receive raw data from storage device controller 128 to encode, and to receive encoded data (e.g., one or more codewords) from the NVM devices to decode. Using error detection and correction circuitry 126 in each offload controller 130, data encoding and decoding is performed locally by each offload controller 130, and thus data encoding and decoding is decentralized and the scalability of storage system 100 is improved.

In some implementations, a respective memory channel 160 of the memory channels 160-1 to 160-M includes a single NVM device while in other implementations the respective memory channel includes a plurality of NVM devices. In some implementations, NVM devices 140, 142 include NAND-type flash memory or NOR-type flash memory. Further, in some implementations, offload controller 130 comprises a solid-state drive (SSD) controller.

In some embodiments, NVM devices 140, 142 are flash memory chips or die, sometimes herein called flash memory devices. Each NVM device includes a number of addressable and individually selectable blocks. In some implementations, the individually selectable blocks (sometimes called erase blocks) are the minimum size erasable units in a flash memory device. In other words, each block contains the minimum number of memory cells that can be erased simultaneously. Each block is usually further divided into a plurality of pages and/or word lines, for example, 64 pages, 128 pages, 256 pages or another suitable number of pages. Each page or word line is typically an instance of the smallest individually accessible (readable) portion in a block. In some implementations (e.g., using some types of flash memory), the smallest individually accessible unit of data, however, is a sector, which is a subunit of a page. That is, a block includes a plurality of pages, each page contains a plurality of sectors, and each sector is the minimum unit of data for reading data from the flash memory device.

In some embodiments, the blocks in each NVM device are grouped into a plurality of zones or planes. Each zone or plane can be independently managed to some extent, which increases the degree of parallelism for parallel operations, such as reading and writing data to NVM devices 140, 142.

As noted above, in some embodiments data is written to a storage medium in pages, but the storage medium is erased in blocks. As a result, some of the pages in a respective block in the storage medium may contain invalid (e.g., stale) data, but those pages cannot be overwritten until the entire block containing those pages is erased. In order to write to the pages with invalid data, the pages (if any) with valid data in that block are read and re-written to a new block and the old block is erased (or put on a queue for erasing). This process is called garbage collection. After garbage collection, the new block contains the pages with valid data and may have free pages that are available for new data to be written, and the old block can be erased so as to be available for new data to be written.

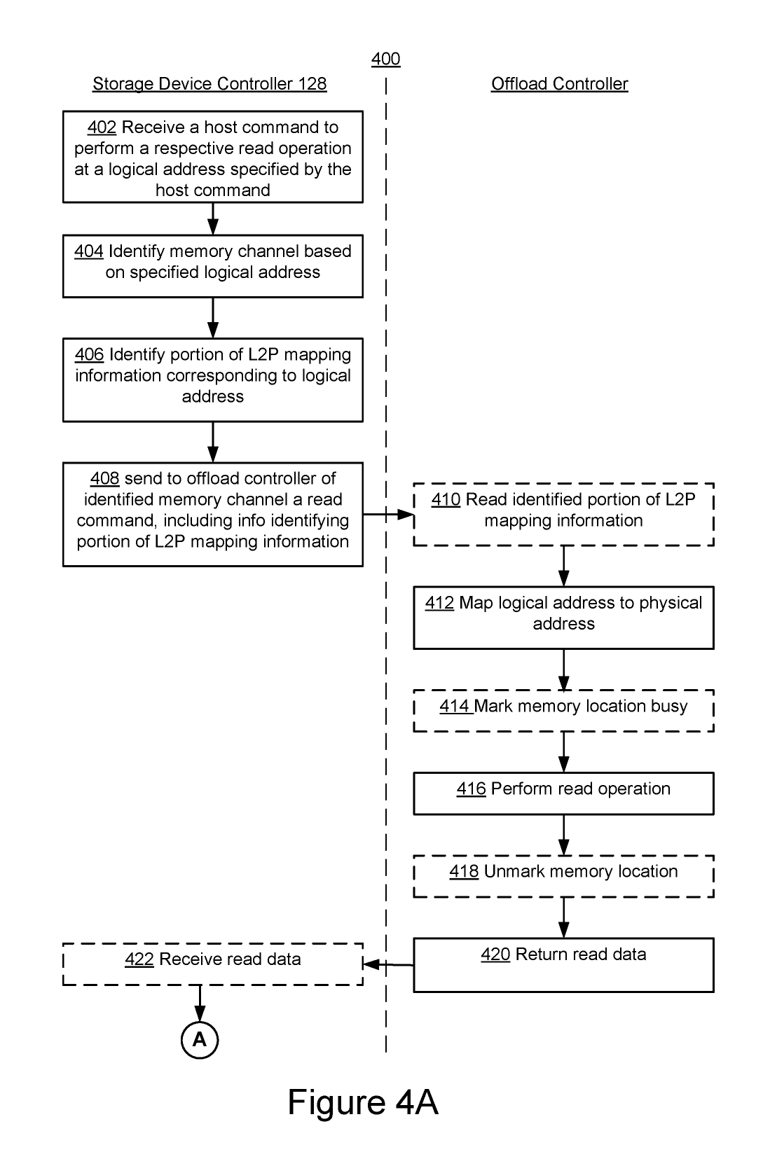

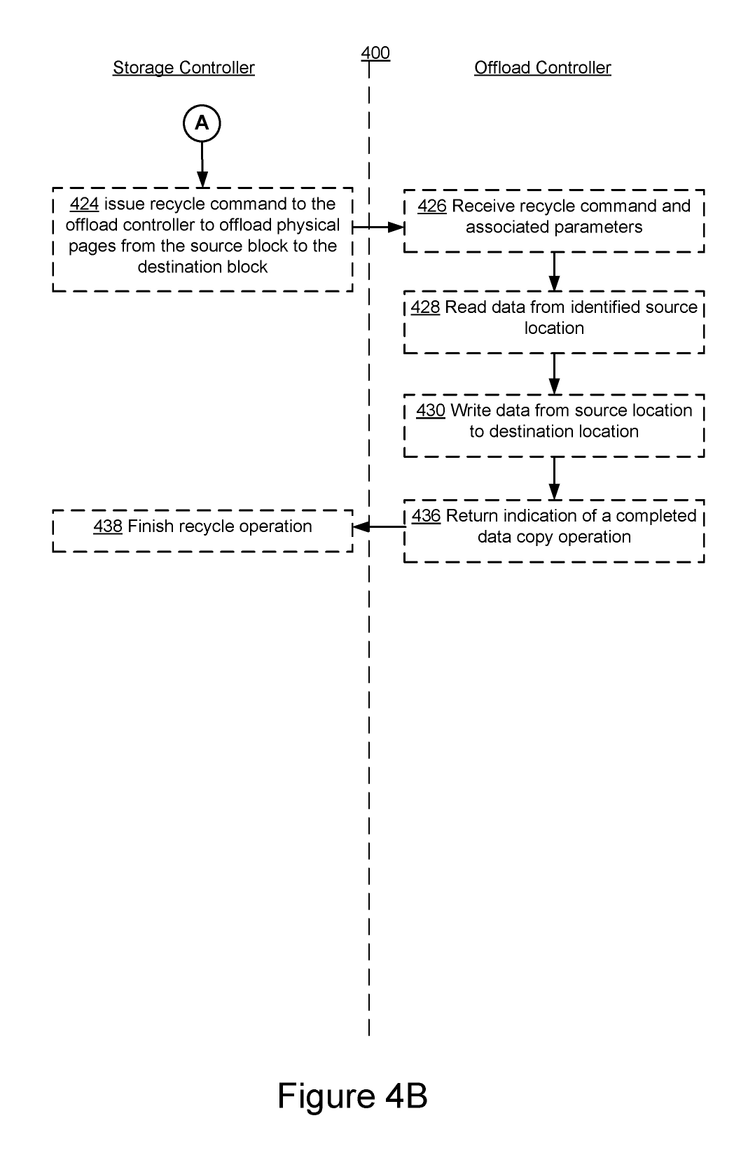

In some embodiments, storage device 120 translates logical addresses received in commands, for example read commands, from computer system 110 into physical addresses using an offload controller 130, which is explained in more detail below with reference to FIGS. 3 and 4A-4B. More specifically, in some embodiments, storage device controller 128 uses a L2P directory 170 to translate a specified logical address into a pointer to a portion, herein called the identified portion, of the logical to physical (L2P) address translation table that contains the physical address for the specified logical address. The identified portion of the L2P address translation table is located in the same memory channel 160 that contains the physical locations specified by the entries in the identified portion of the L2P address translation table.

Memory channels 160 each store an L2P lookup table 242. The L2P lookup table 242 in each memory channel 160 stores address mapping information for mapping logical address into physical addresses in that memory channel. When processing a read command that specifies a logical address, a memory channel 160 corresponding to the logical address is identified by storage device controller 128 using L2P directory 170, and the L2P lookup table 242 in the identified memory channel 160 is used by the offload controller 130 in the identified memory channel to map or translate the logical address into a physical address in the identified memory channel 160.

In some embodiments, in addition to storing address mapping information, L2P lookup table 242 stores other information to facilitate memory operations, such as a valid flag value indicating whether the data stored at a particular physical address is valid.

During a write operation, host interface 122 receives a write command, which includes data to be stored in storage device 120 from computer system 110. The received data, sometimes called write data, is encoded using encoder 133 of storage device controller 128 or using error detection and correction circuitry 126 of a respective offload controller 130, depending on the embodiment, to produce encoded data, typically in the form of one or more codewords. The resulting encoded data is stored in non-volatile memory of a particular memory channel 160.

During a read operation, host interface 122 receives a read command from computer system 110. In response, data read from non-volatile memory of a particular memory channel 160 is decoded using decoder 134 of storage device controller 128 or using error detection and correction circuitry 126 of a respective offload controller 130, depending on the embodiment, to produce decoded data. The resulting decoded data, sometimes called read data, is provided to computer system 110 in response to the read command, via host interface 122.

As explained above, a storage medium (e.g., NVM devices 140, 142) is divided into a number of addressable and individually selectable blocks and each block is typically further divided into a plurality of pages, and/or word lines and/or sectors (which are sub-portions of pages). While erasure of a storage medium is performed on a block basis, in reading and programming of the storage medium is performed on units of memory that are smaller than a block, such as a page or word line or sector of a page, each of which has multiple memory cells (e.g., single-level cells or multi-level cells). For example, in some embodiments, programming is performed on an entire page. In some embodiments, a multi-level cell (MLC) NAND flash has four possible states per cell, yielding two bits of information per cell. Further, in some embodiments, a MLC NAND has two page types: (1) a lower page (sometimes called a fast page), and (2) an upper page (sometimes called a slow page). In some embodiments, a triple-level cell (TLC) NAND flash has eight possible states per cell, yielding three bits of information per cell. Although the description herein uses TLC, MLC, and SLC as examples, those skilled in the art will appreciate that the embodiments described herein may be extended to memory cells that have more than eight possible states per cell, yielding more than three bits of information per cell. In some embodiments, the encoding format of the storage media (e.g., TLC, MLC, or SLC and/or a chosen data redundancy mechanism) is a choice made (or implemented) when data is actually written to the storage media.

Flash memory devices (e.g., NVM 140, 142) utilize memory cells (e.g., SLC, MLC, and/or TLC) to store data as electrical values, such as electrical charges or voltages. Each flash memory cell typically includes a single transistor with a floating gate that is used to store a charge, which modifies the threshold voltage of the transistor (e.g., the voltage needed to turn the transistor on). The magnitude of the charge, and the corresponding threshold voltage the charge creates, is used to represent one or more data values. In some embodiments, during a read operation, a reading threshold voltage is applied to the control gate of the transistor and the resulting sensed current or voltage is mapped to a data value.

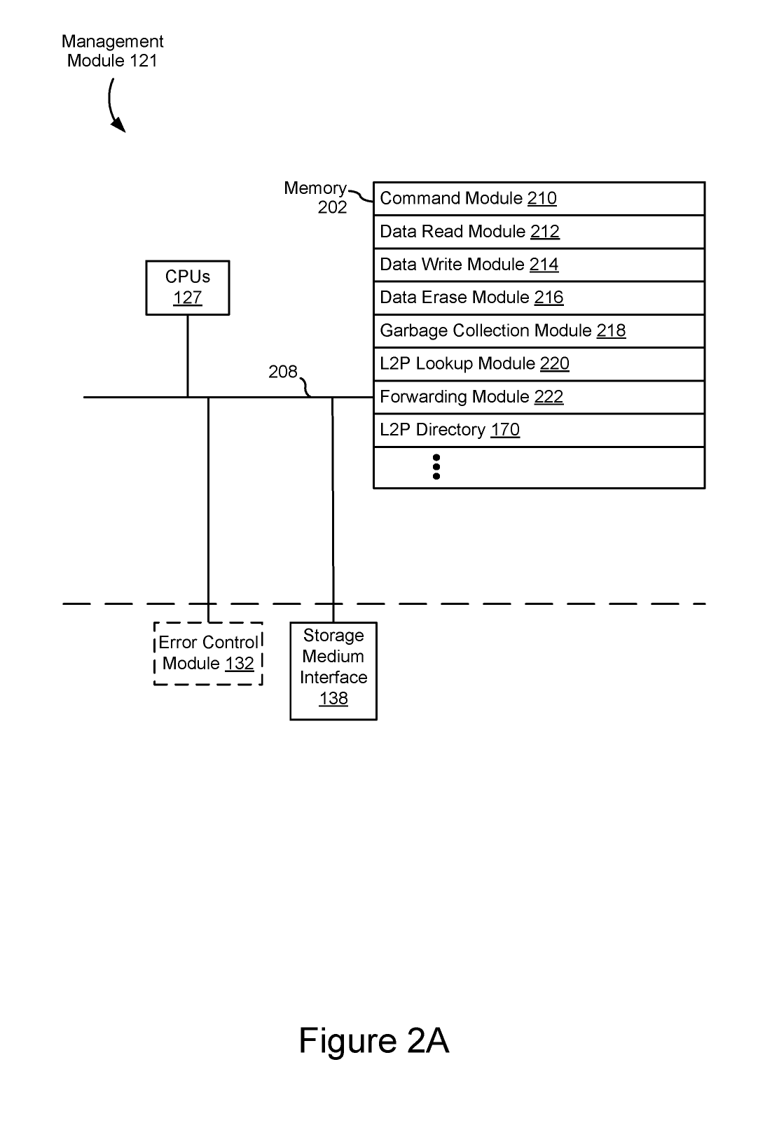

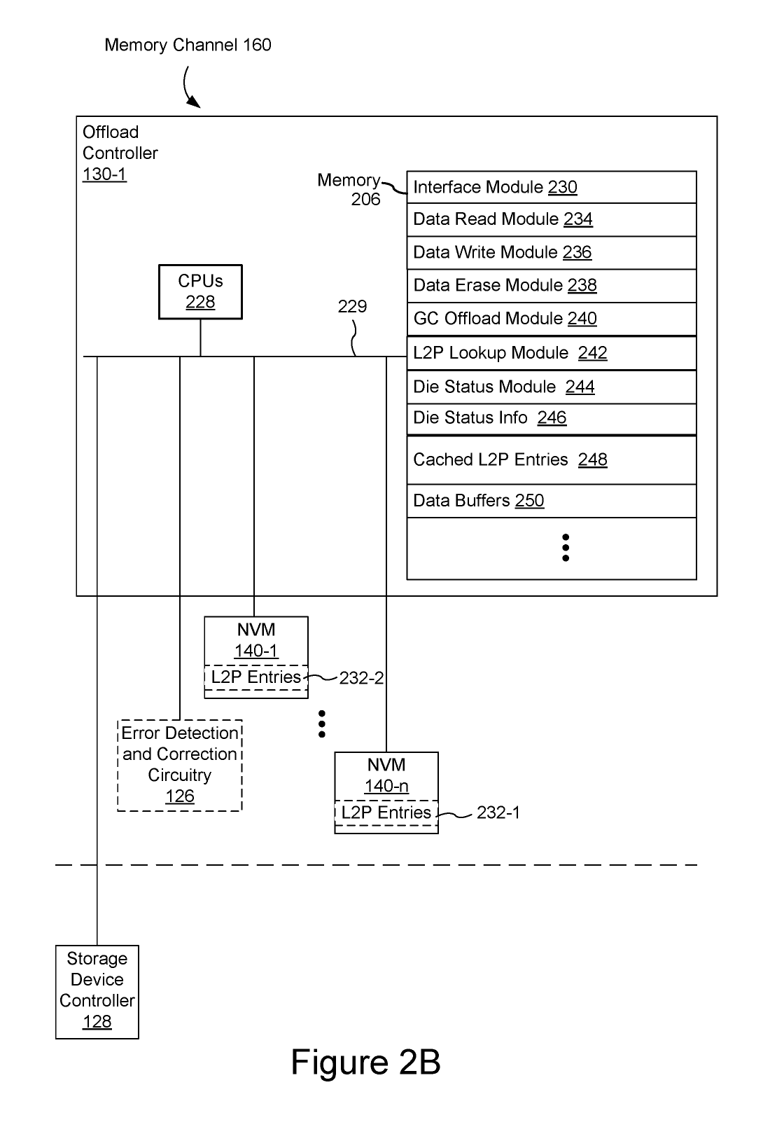

FIG. 2A illustrates a block diagram of a management module 121 in accordance with some embodiments. Management module 121 typically includes: one or more processing units 127 (sometimes herein called CPUs, processors, or hardware processors, and sometimes implemented using microprocessors, microcontrollers, or the like) for executing modules, programs and/or instructions stored in memory 202 and thereby performing processing operations. Management module 121 also includes memory 202 (sometimes herein called controller memory), and one or more communication buses 208 for interconnecting these components. Communication buses 208 optionally include circuitry (sometimes called a chipset) that interconnects and controls communications between system components. Management module 121 is coupled by communication buses 208 to storage medium interface 138 and, optionally, to error control module 132 if storage device controller 128 includes an error control module 132. It is noted that the components represented in FIG. 2A may vary depending on the configuration of a particular storage device, and that the representations shown in FIG. 2A, configured according to FIG. 1, are merely non-limiting examples.

Memory 202 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. Memory 202 optionally includes one or more storage devices remotely located from the CPU(s) 127. In some embodiments, memory 202, or alternatively the non-volatile memory device(s) within memory 202, comprises a non-transitory computer readable storage medium. In some embodiments, memory 202, or the non-transitory computer readable storage medium of memory 202, stores the following programs, modules, and data structures, or a subset or superset thereof:
command module (sometimes called an interface module) 210 for receiving or accessing a host command specifying an operation to be performed and a logical address corresponding to a portion of non-volatile memory within the storage device;
data read module 212 for reading data from non-volatile memory (e.g., NVM devices 140, 142) in memory channels 160 (FIG. 1);
data write module 214 for writing data to non-volatile memory (e.g., NVM devices 140, 142) in memory channels 160;
data erase module 216 for erasing data in non-volatile memory (e.g., NVM devices 140, 142) in memory channels 160;
garbage collection module 218 for controlling garbage collection in the storage device 120;
L2P directory 170 for storing information indicating the locations, in the memory channels, of respective portions to the logical to physical address map entries for the storage device;
L2P lookup module 220 for looking up, in L2P directory 170, the location in a respective memory channel of the logical to physical address map entry (e.g., see FIG. 3) for any given logical address, such as the logical address specified by a host command; and
a forwarding module 222 for forwarding a command, corresponding to the host command, to a memory channel 160 of the plurality of memory channels 160 identified based on the logical address specified by a host command.

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 202 may store a subset of the modules and data structures identified above. Furthermore, memory 202 may store additional modules and data structures not described above. In some embodiments, the programs, modules, and data structures stored in memory 202, or the non-transitory computer readable storage medium of memory 202, provide instructions for implementing any of the methods described below with reference to FIGS. 4A-4B. Stated another way, the programs or modules stored in memory 202, when executed by the one or more processors 127, cause storage device 120 to perform any of the methods described below with reference to FIGS. 4A-4B.

Although FIG. 2A shows a management module 121, FIG. 2A is intended more as functional description of the various features which may be present in a management module than as a structural schematic of the embodiments described herein. In practice, and as recognized by those of ordinary skill in the art, items shown separately could be combined and some items could be separated.

FIG. 2B is a block diagram illustrating an implementation of a memory channel 160, in accordance with some embodiments. Memory channel 160 includes an offload controller 130, which in turn includes one or more processing units 228 (sometimes herein called CPUs, processors, or hardware processors, and sometimes implemented using microprocessors, microcontrollers, or the like) for executing modules, programs and/or instructions stored in memory 206 (sometimes herein called controller memory) and thereby performing processing operations; and memory 206. Memory channel 160 further includes NVM devices 140 (or NVM devices 142), and one or more communication buses 229 for interconnecting these components of memory channel 160. NVM devices 140 further include L2P entries 232 (e.g., entries 232-1 and 232-2). The L2P entries 232 map logical addresses to physical addresses in memory channel 160, as further described below with respect to FIG. 3. Communication buses 229 optionally include circuitry (sometimes called a chipset) that interconnects and controls communications between system components. Memory channel 160 is also coupled to storage device controller 128, for example to receive read, write and erase commands, and optionally data copy or garbage collection commands, to be executed by the memory channel 160.

Memory 206 includes high-speed random access memory, such as DRAM, SRAM, DDR RAM or other random access solid state memory devices, and may include NVM, such as one or more magnetic disk storage devices, optical disk storage devices, flash memory devices, or other non-volatile solid state storage devices. Memory 206 optionally includes one or more storage devices remotely located from offload controller 130. In some embodiments, memory 206, or alternately the non-volatile memory device(s) within memory 206, comprises a non-transitory computer readable storage medium. In some embodiments, memory 206, or the computer readable storage medium of memory 206 stores the following programs, modules, and data structures, or a subset thereof:
interface module 230 for communicating with other components, such as storage device controller 128, and error detection and correction circuitry 126 (if included in the memory channel);
data read module 234 for reading data from NVM devices 140;
data write module 236 for writing data to NVM devices 140;
data erase module 238 for erasing portions of non-volatile memory in NVM devices 140;
garbage collection offload module 240 for copying data from a source location to a destination location, where both locations are within the non-volatile memory in NVM devices 140 of the memory channel;
L2P lookup module 242 to translate logical addresses to physical addresses in memory channel 160, using L2P entries (e.g., L2P entries 232) stored in NVM devices 140 in memory channel 160;
die status module 244 for marking individual NVM die (e.g., NVM devices 140) as busy when data is being read from, and optionally when data is being written to, those NVM die;
die status information 246 for indicating which NVM die in the memory channel have been marked busy;
cached L2P entries 248, which are cached copies of L2P entries (e.g., L2P entries 232-1, 232-2), temporarily stored in random access memory of the memory channel's offload controller; and
data buffers 250 to temporarily store data read from NVM devices 140 in memory channel 160, and/or to temporarily store data to be written to NVM devices 140 in memory channel 160.

As noted above, in some embodiments, each memory channel 160 has its own L2P entries 232 for mapping logical addresses into physical address in the memory channel 160. Data structures for implementing L2P entries are described below with reference to FIG. 3.

Each of the above identified elements may be stored in one or more of the previously mentioned storage devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 206 may store a subset of the modules and data structures identified above. Furthermore, memory 206 may store additional modules and data structures not described above. In some embodiments, the programs, modules, and data structures stored in memory 206, or the computer readable storage medium of memory 206, include instructions for implementing respective operations in the methods described below with reference to FIGS. 4A-4B.

Although FIG. 2B shows memory channel 160 in accordance with some embodiments, FIG. 2B is intended more as a functional description of the various features which may be present in a memory channel 160 than as a structural schematic of the embodiments described herein. In practice, and as recognized by those of ordinary skill in the art, items shown separately could be combined and some items could be separated. Further, the above description of memory channel 160 applies to each of the memory channels 160-1 to 160-m of storage device 120 (FIG. 1).

FIG. 3 illustrates various logical to physical memory address translation data structures, in accordance with some embodiments. In some embodiments, portions of a logical to physical (L2P) address translation table 330 are stored in the various memory channels 160-1 to 160-m. The portion of L2P address translation table 330 stored in each memory channel 160 is sometimes called a partition of L2P address translation table 330, and each partition includes a set of pages 332 (e.g., pages 332-1-1 to 332-1-j in memory channel 160-1; and pages 332-m-1 to 332-m-k in memory channel 160-m), each of which includes a set of L2P map entries (e.g., L2P map entries 334-1-1 to 334-1-p for page 332-1-2). Because different amounts of data may be stored in the various memory channels, different memory channels may have different numbers of pages 332 of L2P address translation table 330, and similarly may have different numbers of L2P map entries 334.

Storage device controller 128 includes L2P directory 170, which includes multiple L2P directory entries 302 (e.g., entries 302-1 to 302-e). In some embodiments, a respective L2P directory entry 302 indicates the location (e.g., a physical address), in a memory channel, of a page 332 or other grouping of logical to physical map entries 334.

In some embodiments, within each memory channel, L2P map entries 334 are grouped together and stored in L2P pages 332. Typically, each L2P page 332 stores physical addresses for hundreds or thousands of logical addresses (e.g., between 100 and 10,000 logical addresses).

For a specified logical address, such as the logical address specified by a received host command, storage device controller 128 performs a lookup in the L2P directory 170, using a first portion (e.g., a predefined number of the most significant bits) of the specified logical address, to determine the L2P page 332 where the L2P map entry 334 for that specified logical address is stored. When a read command for reading data from the specified logical address is sent by storage device controller 128 to the offload controller of a memory channel 160, the information identifying this L2P page 332 is sent as part of the read command, or alternatively is sent along with the read command, to the offload controller 130 of the memory channel 160.

FIGS. 4A-4B illustrates a flowchart representation of method 400 of operating a storage device having a plurality of memory channels 160, in accordance with some embodiments. At least in some implementations, method 400 is performed by a storage device (e.g., storage device 120, FIG. 1A) that includes non-volatile memory, or one or more components of the storage device (e.g., offload controllers 130 and/or storage device controller 128, FIG. 1B).

Method 400 includes receiving (402) at the storage device a host command to perform a read operation on a portion of the storage device's non-volatile memory corresponding to a logical address specified by the host command. For example, a storage device (e.g., storage device 120, FIG. 1A) receives or accesses a host command to read data from a block of memory, for example, a block of memory on one of NVM devices 140, 142. In some embodiments, NVM devices 140, 142 are, or include, one or more flash memory devices. The host command is typically received from a host device or system, such as computer system 110 shown in FIG. 1.

Method 400 further includes, at a storage controller for the storage device (e.g., storage device controller 128, FIG. 1), identifying (404), based on the specified logical address, a memory channel of a plurality of memory channels 160. As discussed above with reference to FIGS. 2B and 3, in some embodiments, each memory channel 160 of the plurality of memory channels 160 includes a portion of the storage device's non-volatile memory (e.g., a block of memory on one of NVM devices 140, 142), an offload controller 130, and logical to physical (L2P) address mapping information for the portions of the storage device's non-volatile memory in the memory channel.

The logical address space for the storage device is split among the memory channels 160. For a specified logical address, the corresponding memory channel is determined or identified using a portion of the specified logical address, such as a subset of the bits of the specified logical address. In some embodiments, the portion of the specified logical address used to identify the memory channel is a portion other than the r most significant bits, where r is typically a value between 2 and 10. In one example, for a storage device with sixteen memory channels, the portion of the specified logical address used to identify the memory channel are address bits 15 to 18, or address bits 19 to 22, where the specified logical address has address bits 1 to 32, and address bit 1 is the most significant bit and address bit 32 is the least significant bit.

The method further includes, at the storage controller, identifying (406), based on the specified logical address, a portion of L2P address mapping information in the identified memory channel 160. For example, as explained with respect to FIG. 3, in some embodiments an L2P directory 170 is used to identify a portion of L2P address mapping information in the identified memory channel 160, based on the specified logical address. In some embodiments, identifying (406) the portion of the L2P mapping information includes identifying a page of an L2P log and an offset, within the identified page of the L2P log, corresponding to the specified logical address, where the identified page of the L2P log is stored in the identified memory channel. For example, in some embodiments, the page of the L2P log is identified using an L2P directory to map a first portion of the specified logical address to a corresponding page of the L2P log. In addition, in some embodiments, the offset within that page is based on a second portion of the specified logical address (e.g., a predefined number of bits of the specified logical address that are less significant that the bits in the first portion of the specified logical address).

Following the identification step (406), the storage controller sends (408) to the offload controller of the identified memory channel, a read command. The read command includes at least a portion of the logical address specified by the received host command and information (e.g., a physical address) identifying the identified portion of the L2P address mapping information in the identified memory channel 160. In some embodiments, the read command includes the entire logical address specified by the received host command, while in other embodiments the read command includes the entire logical address specified by the received host command excluding one or more of the address bits used to identify the memory channel.

The operations described above are performed at the storage controller (128). At the offload controller 130 in the specified memory channel 160, the method further includes mapping (412) the logical address specified by the received host command to a physical address using the identified portion of the L2P address mapping information in the identified memory channel. Thus, the physical address corresponds to the logical address specified by the host command.

In some embodiments, prior to mapping the logical address specified by the received host command to a physical address, a page with the identified portion of the L2P address mapping information is read (410) by the offload controller, for example from non-volatile memory in the identified memory channel, using the information, identifying the identified portion of the L2P address mapping information, that is included in the read command (or sent along with the read command) sent by the storage controller to the offload controller. Thus, the read operation for obtaining the identified portion of the L2P address mapping information is performed prior to performing the mapping (412) to a physical address.

The method further includes. at the offload controller of the identified memory channel, performing (416) the respective read operation on a portion of the non-volatile memory in the identified memory channel identified by the physical address. As a result, the data requested by the received host command is read from non-volatile memory in the identified memory channel.

In some embodiments, the memory location is marked (414) as busy while performing the read operation (416). The memory location is subsequently unmarked (418) as busy after the read operation has been performed.

After performing the respective read operation, the method returns (420) read data obtained by performing the respective read operation to the storage controller. In some embodiments, the read data is received (422) by the storage controller, which in turn returns the read data to the host from which the host command was received. In some embodiments, returning the read data (420) to the storage controller includes sending an interrupt to the storage controller. In some embodiments, the host command includes a buffer identifier or address, and returning the read data includes copying the read data to a buffer location corresponding to the buffer identifier or address.

In some embodiments not shown in FIG. 4A, offload controllers 130 of the plurality of memory channels 160 individually execute respective read operations in parallel (i.e., during overlapping time periods).

In some embodiments, method 400 further includes the storage controller issuing (424) a recycle command, sometimes called a garbage collection command, to the offload controller of an identified memory channel. The recycle command is a command to copy one or more pages of data from a source block to a destination block. In some embodiments, the offload controller in each memory channel of the plurality of memory channels includes a garbage collection module (e.g., GC offload module 240, FIG. 2B) to copy data from a source location to a destination location, wherein the source location and destination location are both located within the portion of the non-volatile memory of the storage device in the memory channel. In some embodiments, the recycle command issued (424) by the storage controller is processed by the garbage collection module in the offload controller that receives the recycle command.

In conjunction with receiving the issued recycle command, the offload controller 130 receives (426) from the storage controller a plurality of parameters including: parameters identifying a source location, such as a source physical block and page number (e.g., a first physical address); information identifying a destination location, such as a destination physical block and page number (e.g., a second physical address); and, optionally, a number of pages of data (or other units of data) to be copied. The source physical block and destination physical block are both located within the portion of the non-volatile memory of the storage device in the respective memory channel. In some embodiments, the plurality of parameters are parameters included in the received recycle command.

The method further includes, at the offload controller in the identified memory channel, reading (428) the specified number of pages of data (or other units of data) from the source location, and writing (430) the data read from the source location to the destination location. Optionally, the source location is marked as busy while data is read (428) from it, and is subsequently unmarked after the data is read from the source location. Similarly, optionally, the destination location is marked as busy while data is written (430) to it, and is subsequently unmarked after the data is written to the destination location.

In some embodiments, an indication is returned (436) by the offload controller to indicate that the copying of data from the source location to the destination location has been completed. In response, the storage controller finishes (438) the recycle operation, for example by updating address mapping information for the data that was copied from the source location to the destination location.

By sending recycle commands to the offload controllers, the storage controller can more efficiently handle garbage collection operations, by offloading the copying of data from source locations to destination locations to the offload controllers of the memory channels. This also enables the storage controller to initiate data copying operations, for garbage collection, in multiple memory channels to be performed in parallel (i.e., during overlapping time periods).

It will be understood that, although the terms “first,” “second,” etc. may be used herein to describe various elements, these elements should not be limited by these terms. These terms are only used to distinguish one element from another. For example, a first contact could be termed a second contact, and, similarly, a second contact could be termed a first contact, which changing the meaning of the description, so long as all occurrences of the “first contact” are renamed consistently and all occurrences of the second contact are renamed consistently. The first contact and the second contact are both contacts, but they are not the same contact.

The terminology used herein is for the purpose of describing particular embodiments only and is not intended to be limiting of the claims. As used in the description of the embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific implementations. However, the illustrative discussions above are not intended to be exhaustive or to limit the claims to the precise forms disclosed. Many modifications and variations are possible in view of the above teachings. The implementations were chosen and described in order to best explain principles of operation and practical applications, to thereby enable others skilled in the art.

What is claimed is:

1. A method for operating a storage device that includes non-volatile memory, comprising:
receiving a host command to perform a respective read operation on a portion of the non-volatile memory corresponding to a logical address specified by the host command;
at a storage controller for the storage device:
identifying, based on the specified logical address, a memory channel of a plurality of memory channels, each memory channel of the plurality of memory channels including a portion of the non-volatile memory of the storage device, an offload controller, and logical to physical (L2P) address mapping information for portions of the non-volatile memory of the storage device in the memory channel;
identifying, based on the specified logical address, a portion of the L2P address mapping information in the identified memory channel; and
sending to the offload controller of the identified memory channel a read command, the read command including at least a portion of the logical address specified by the received host command and information identifying the identified portion of the L2P address mapping information in the identified memory channel;
at the offload controller of the identified memory channel:
mapping the logical address specified by the received host command to a physical address using the identified portion of the L2P address mapping information in the identified memory channel, the physical address corresponding to the logical address specified by the host command;
performing the respective read operation on a portion of the non-volatile memory in the identified memory channel identified by the physical address; and
returning read data obtained by performing the respective read operation.

2. The method of claim 1, wherein:
identifying the portion of the L2P address mapping information in the identified memory channel includes identifying a page of an L2P log and an offset, within the identified page of the L2P log, corresponding to the specified logical address; and
the identified page of the L2P log is stored in the identified memory channel.

3. The method of claim 1, wherein, in the read command, the information identifying the identified portion of the L2P address mapping information in the identified memory channel includes a physical address of the identified portion of the L2P address mapping information.

4. The method of claim 1, wherein:
the read command further includes a buffer identifier or address; and
returning the read data includes copying the read data to a buffer location corresponding to the buffer identifier or address.

5. The method of claim 1, further comprising:
at the offload controller of the identified memory channel:
marking a physical memory location as busy while performing the respective read operation; and
unmarking the physical memory location as busy after completion of the respective read operation.

6. The method of claim 1, wherein the offload controllers of the plurality of memory channels each individually execute respective read operations.

7. The method of claim 1, wherein:
each offload controller in the plurality of memory channels includes a garbage collection module to copy data from a source location to a destination location; and
the source location and destination location are both located within the portion of the non-volatile memory of the storage device in the memory channel that includes the offload controller.

8. The method of claim 7, wherein:
the garbage collection module in a respective offload controller, for a respective memory channel, receives from the storage controller a plurality of parameters including:
a source physical block and page number;
a destination physical block and page number; and
a number of pages of data to be copied; and
the source physical block and destination physical block are both located within the portion of the non-volatile memory of the storage device in the respective memory channel.

9. The method of claim 1, wherein returning the read data includes sending an interrupt to the storage controller.

10. A storage device that includes non-volatile memory, the storage device comprising:
an interface for coupling the storage device to a host system, and for receiving a host command to perform a respective read operation on a portion of the non-volatile memory corresponding to a logical address specified by the host command;
a plurality of memory channels, each memory channel of the plurality of memory channels including a portion of the non-volatile memory of the storage device, an offload controller, and logical to physical (L2P) address mapping information for portions of the non-volatile memory of the storage device in the memory channel; and
a storage controller having one or more hardware processors, the storage controller configured to:
identify, based on the specified logical address, a memory channel of the plurality of memory channels;
identify, based on the specified logical address, a portion of the L2P address mapping information in the identified memory channel; and
send to the offload controller of the identified memory channel, a read command, the read command including at least a portion of the logical address specified by the received host command and information identifying the identified portion of the L2P address mapping information in the identified memory channel;
wherein the offload controller of the identified memory channel is configured to:
map the logical address specified by the received host command to a physical address using the identified portion of the L2P address mapping information in the identified memory channel, the physical address corresponding to the logical address specified by the host command;
perform the respective read operation on a portion of the non-volatile memory in the identified memory channel identified by the physical address; and
return read data obtained by performing the respective read operation.

11. The storage device of claim 10, wherein:
the storage controller is configured to identify the portion of the L2P address mapping information in the identified memory channel by identifying a page of an L2P log and an offset, within the identified page of the L2P log, corresponding to the specified logical address; and
the identified page of the L2P log is stored in the identified memory channel.

12. The storage device of claim 10, wherein, in the read command, the information identifying the identified portion of the L2P address mapping information in the identified memory channel includes a physical address of the identified portion of the L2P address mapping information.

13. The storage device of claim 10, wherein:
the read command further includes a buffer identifier or address; and
the offload controller of the identified memory channel is configured to return the read data by copying the read data to a buffer location corresponding to the buffer identifier or address.

14. The storage device of claim 10, wherein the offload controllers of the plurality of memory channels are configured to individually execute respective read operations.

15. The storage device of claim 10, wherein the offload controller of the identified memory channel is further configured to:
mark a physical memory location as busy while performing the respective read operation; and
unmark the physical memory location as busy after completion of the respective read operation.

16. The storage device of claim 10, wherein:
each offload controller in the plurality of memory channels includes a garbage collection module to copy data from a source location to a destination location; and
the source location and destination location are both located within the portion of the non-volatile memory of the storage device in the memory channel that includes the offload controller.

17. The storage device of claim 16, wherein:
the garbage collection module in a respective offload controller, for a respective memory channel, is configured to receive from the storage controller a plurality of parameters including:
a source physical block and page number;
a destination physical block and page number; and
a number of pages of data to be copied; and
the source physical block and destination physical block are both located within the portion of the non-volatile memory of the storage device in the respective memory channel.

18. The storage device of claim 10, wherein returning the read data includes sending an interrupt to the storage controller.

19. A storage device that includes non-volatile memory, the storage device comprising;
a plurality of memory channels, each memory channel of the plurality of memory channels including a portion of the non-volatile memory of the storage device, and logical to physical (L2P) address mapping information for portions of the non-volatile memory of the storage device in the memory channel;
means for coupling the storage device to a host system, and for receiving a host command to perform a respective read operation on a portion of the non-volatile memory corresponding to a logical address specified by the host command;
means for controlling operation of the storage device, including:
means for identifying, based on the specified logical address, a memory channel of a plurality of memory channels;
means for identifying, based on the specified logical address, a portion of the L2P address mapping information in the identified memory channel;
means for sending to the identified memory channel, a read command, the read command including at least a portion of the logical address specified by the received host command and information identifying the identified portion of the L2P address mapping information in the identified memory channel; and
means for controlling operation of the identified memory channel, including:
means for mapping the logical address specified by the received host command to a physical address using the identified portion of the L2P address mapping information in the identified memory channel, the physical address corresponding to the logical address specified by the host command;
means for performing the respective read operation on a portion of the non-volatile memory in the identified memory channel identified by the physical address; and
means for returning read data obtained by performing the respective read operation.

20. The storage device of claim 19, wherein:
the means for identifying the portion of the L2P address mapping information in the identified memory channel is configured to identify the portion of the L2P address mapping information in the identified memory channel by identifying a page of an L2P log and an offset, within the identified page of the L2P log, corresponding to the specified logical address; and
the identified page of the L2P log is stored in the identified memory channel.
